(19) United States
(12) Patent Application Publication
(10) Pub. No.: US 2013/0010292 A1
(43) Pub. Date: Jan. 10, 2013

(54) INFORMATION ACQUIRING DEVICE, PROJECTION DEVICE AND OBJECT DETECTING DEVICE

(75) Inventors: Katsumi UMEDA, Niwa-gun (JP); Yoichiro Goto, Gifu-shi (JP)

(73) Assignee: Sanyo Electric Co., Ltd., Moriguchi-shi (JP)

(21) Appl. No.: 13/614,708

(22) Filed: Sep. 13, 2012

Related U.S. Application Data
(63) Continuation of application No. PCT/JP2012/058511, filed on Mar. 30, 2012.

(30) Foreign Application Priority Data
Apr. 5, 2011 (JP) 2011-83982
May 25, 2011 (JP) 2011-116706

(51) Int. Cl. G02B 27/32

(52) U.S. Cl. 356/247

(57) ABSTRACT

A projection optical system is provided with a diffractive optical element which converts laser light emitted from a laser light source into light having a dot pattern by diffraction and projects laser light onto a target area with a predetermined dot pattern. The diffractive optical element is formed in such a manner that the density of dots in a peripheral portion of a target area is set larger than the density of dots in a center portion of the target area. With this arrangement, in performing a pattern matching operation for a segment area in the vicinity of the outer side of the target area, the number of dots to be included in the segment area increases. This enhances the precision in the pattern matching operation.

This application claims priority under 35 U.S.C. Section 119 of Japanese Patent Application No. 2011-116706 filed May 25, 2011, entitled “INFORMATION ACQUIRING DEVICE, PROJECTION DEVICE AND OBJECT DETECTING DEVICE”. The disclosure of the above applications is incorporated herein by reference.

### BACKGROUND OF THE INVENTION

1. Field of the Invention

The present invention relates to an object detecting device for detecting an object in a target area, based on a state of reflected light when light is projected onto the target area, an information acquiring device incorporated with the object detecting device, and a projection device to be loaded in the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

A distance image sensor configured to irradiate a target area with laser light having a predetermined dot pattern is operable to receive reflected light of laser light having a dot pattern from the target area by a light receiving element. Then, a distance to each portion of an object to be detected (an irradiation position of each dot on an object to be detected) is detected, based on a light receiving position of each dot on the light receiving element, using a triangulation method (see e.g. pp. 1279-1280, the 19th Annual Conference Proceedings (Sep. 18-20, 2001) by the Robotics Society of Japan).

In the object detecting device thus constructed, laser light having a dot pattern is generated by diffracting laser light emitted from a laser light source by a diffractive optical element. In this arrangement, the diffractive optical element is so designed that e.g. a dot pattern on a target area is uniformly distributed with the same luminance. However, the luminance of each dot on the target area may not be always uniform and a luminance variation may occur resulting from e.g. an error in the diffractive optical element. As a result, a dot having a low luminance is likely to merge into light (stray light) such as natural light or interior light, and distance detection precision may be degraded at the irradiation position of such a dot.

### SUMMARY OF THE INVENTION

A first aspect of the invention is directed to an information acquiring device for acquiring information on a target area using light. The information acquiring device according to the first aspect includes a projection optical system which projects laser light onto the target area with a predetermined dot pattern; and a light receiving optical system which is aligned with the projection optical system in a certain direction away from the projection optical system with a predetermined distance, and captures an image of the target area. In this arrangement, the projection optical system includes a laser light source, and a diffractive optical element which converts laser light emitted from the laser light source into light having a dot pattern by diffraction. The light receiving optical system includes an image sensor, and a condensing lens which condenses light from the target area on the image sensor. The diffractive optical element is formed in such a manner that a density of dots in a peripheral portion of the dot pattern is set larger than a density of dots in a center portion of the dot pattern in the target area.

A second aspect of the invention is directed to a projection device. The projection device according to the second aspect is provided with the projection optical system of the first aspect.

A third aspect of the invention is directed to an object detecting device. The object detecting device according to the third aspect has the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of an object detecting device embodying the invention.

FIG. 2 is a diagram showing an arrangement of an information acquiring device and an information processing device in the embodiment.

FIGS. 3A and 3B are diagrams respectively showing an irradiation state of laser light onto a target area, and a light receiving state of laser light on an image sensor in the embodiment.

FIGS. 4A and 4B are diagrams schematically showing a reference template generating method in the embodiment.

FIGS. 5A through 5C are diagrams for describing a method for detecting a shift position of a segment area of a reference template at the time of actual measurement in the embodiment.

FIG. 6 is a perspective view showing an installation state of a projection optical system and a light receiving optical system in the embodiment.

FIG. 7 is a diagram schematically showing an arrangement of the projection optical system and the light receiving optical system in the embodiment.

FIG. 8 is a diagram showing a simulation example of a dot pattern in a target area in the embodiment.

FIG. 9 shows a measurement result indicating a luminance distribution on a CMOS image sensor in the embodiment.

FIG. 10 is a diagram schematically showing a dot distribution state in a target area in the embodiment.

FIGS. 11A and 11B are diagrams schematically showing modification examples of a dot distribution state in a target area in the embodiment.

FIGS. 12A and 12B are diagrams for describing an effect of the embodiment.

FIGS. 13A and 13B are diagrams schematically showing a dot distribution state in a target area in modification examples.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, there is exemplified an information acquiring device for irradiating a target area with laser light having a predetermined dot pattern.

In the embodiment, a DOE 114 corresponds to a “diffractive optical element” in the claims. An imaging lens 122 corresponds to a “condensing lens” in the claims. A CMOS image sensor 123 corresponds to an “image sensor” in the claims. The description regarding the correspondence between the claims and the embodiment is merely an example, and the claims are not limited by the description of the embodiment.

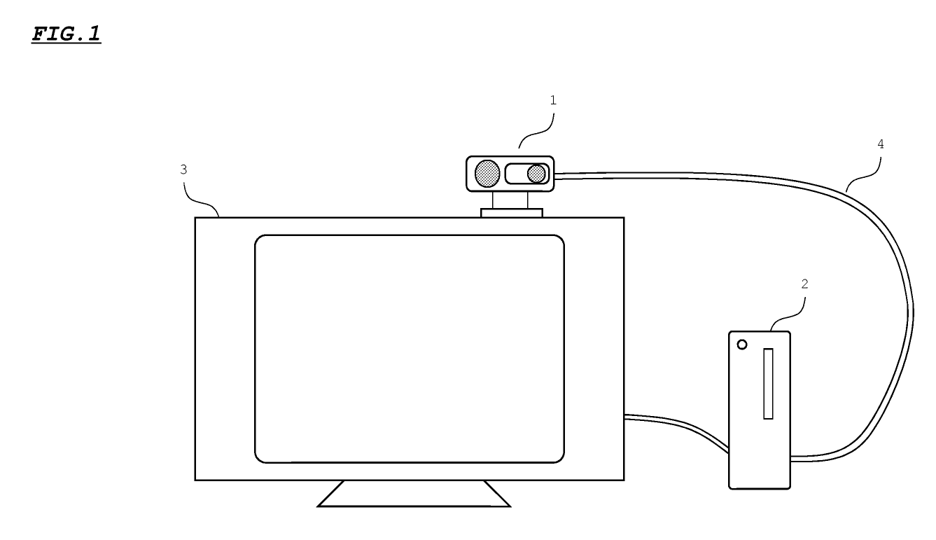

A schematic arrangement of an object detecting device according to the first embodiment is described. As shown in FIG. 1, the object detecting device is provided with an information acquiring device 1, and an information processing device 2. A TV 3 is controlled by a signal from the information processing device 2. A device constituted of the information acquiring device 1 and the information processing device 2 corresponds to an object detecting device of the invention.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

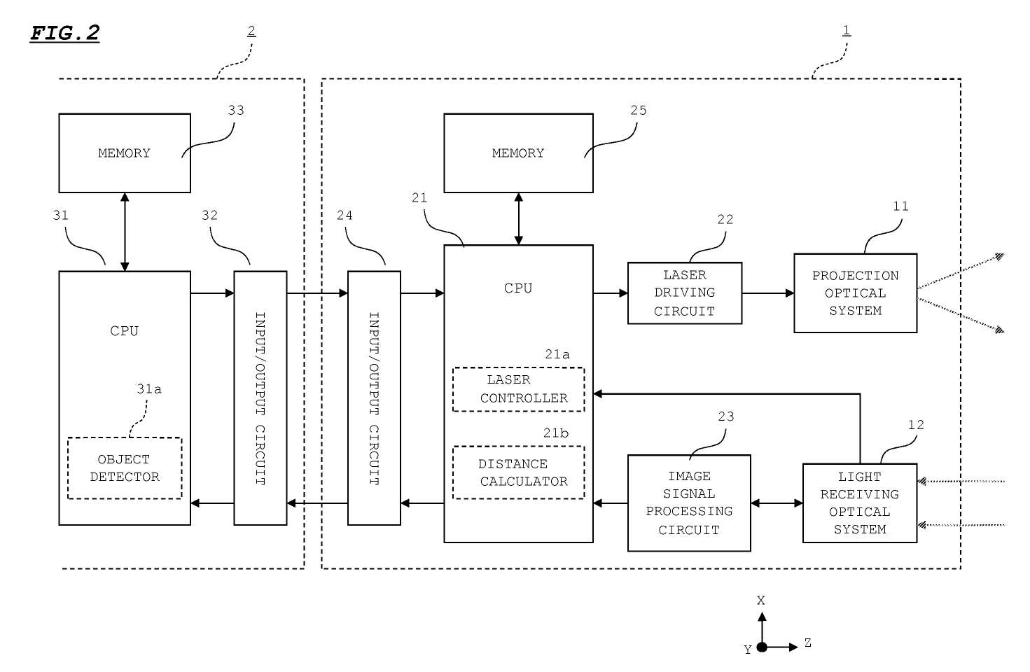

FIG. 2 is a diagram showing an arrangement of the information acquiring device 1 and the information processing device 2.

The information acquiring device 1 is provided with a projection optical system 11 and a light receiving optical system 12, which constitute an optical section. In addition to the above, the information acquiring device 1 is provided with a CPU (Central Processing Unit) 21, a laser driving circuit 22, an image signal processing circuit 23, an input/output circuit 24, and a memory 25, which constitute a circuit section.

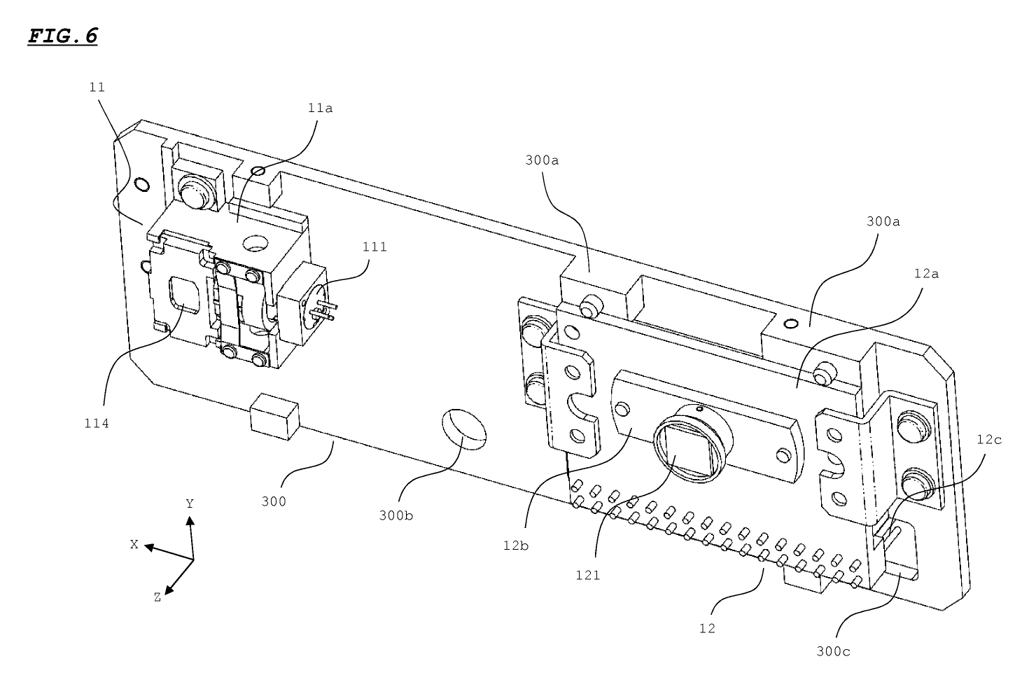

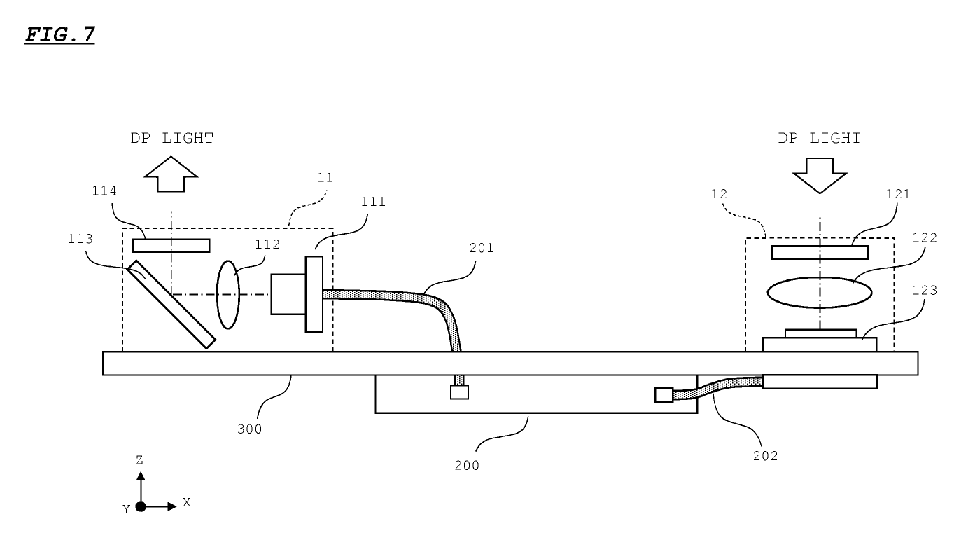

The projection optical system 11 irradiates a target area with laser light having a predetermined dot pattern. The light receiving optical system 12 receives laser light reflected on the target area. The arrangement of the projection optical system 11 and the light receiving optical system 12 will be described later referring to FIGS. 6 and 7.

The CPU 21 controls the parts of the information acquiring device 1 in accordance with a control program stored in the memory 25. By the control program, the CPU 21 has functions of a laser controller 21a for controlling the laser light source 111 (to be described later) in the projection optical system and a three-dimensional distance calculator 21b for generating three-dimensional distance information.

The laser driving circuit 22 drives the laser light source 111 (to be described later) in accordance with a control signal from the CPU 21. The image signal processing circuit 23 controls the CMOS image sensor 123 (to be described later) in the light receiving optical system 12 to successively read signals (electric charges) from the pixels, which have been generated in the CMOS image sensor 123, line by line. Then, the image signal processing circuit 23 outputs the read signals successively to the CPU 21.

The CPU 21 calculates a distance from the information acquiring device 1 to each portion of an object to be detected, by a processing to be implemented by the three-dimensional distance calculator 21b, based on the signals (image signals) to be supplied from the image signal processing circuit 23. The input/output circuit 24 controls data communications with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

The input/output circuit 32 controls data communication with the information acquiring device 1.

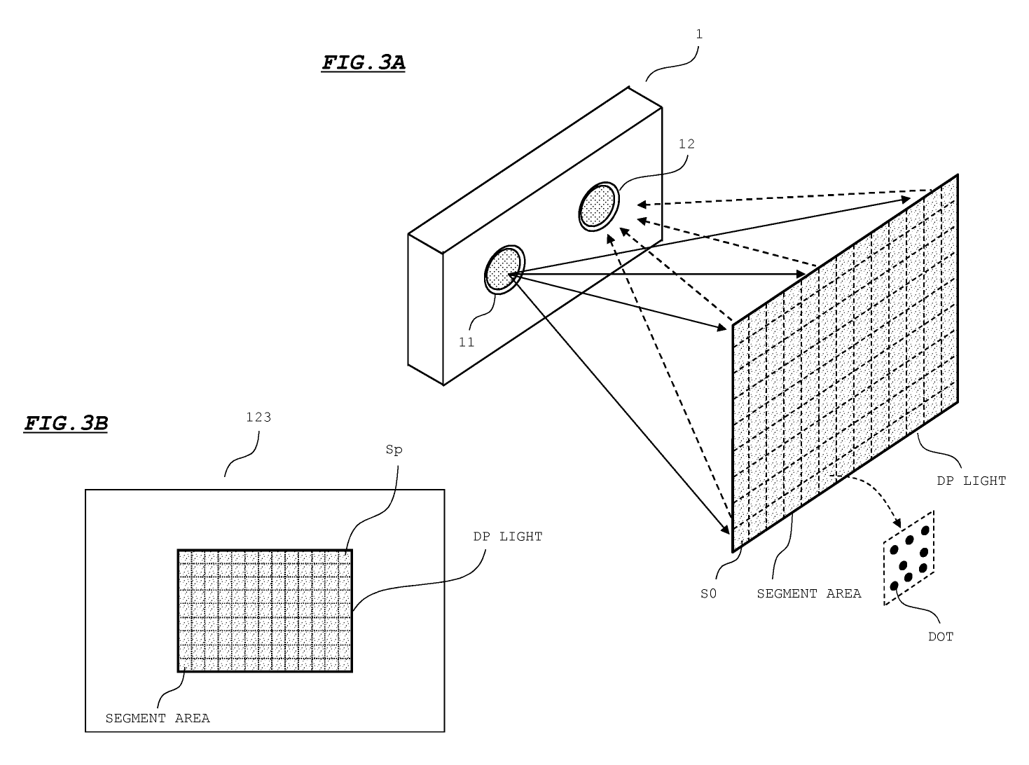

FIG. 3A is a diagram schematically showing an irradiation state of laser light onto a target area. FIG. 3B is a diagram schematically showing a light receiving state of laser light on the CMOS image sensor 123. To simplify the description, FIG. 3B shows a light receiving state in the case where a flat plane (screen) is disposed on a target area.

As shown in FIG. 3A, the projection optical system 11 irradiates laser light having a dot pattern (hereinafter, the entirety of the laser light having the dot pattern is called as “DP light”) toward a target area. FIG. 3A shows a projection area of DP light by a solid-line frame. In the light flux of DP light, dot areas (hereinafter, simply called as “dots”) in which the intensity of laser light is increased by a diffractive action of the diffractive optical element locally appear in accordance with the dot pattern by the diffractive action of the DOE 114.

To simplify the description, in FIG. 3A, a light flux of DP light is divided into segment areas arranged in the form of a matrix. Dots locally appear with a unique pattern in each segment area. The dot appearance pattern in a certain segment area differs from the dot appearance patterns in all the other segment areas. With this configuration, each segment area is identifiable from all the other segment areas by a unique dot appearance pattern of the segment area.

When a flat plane (screen) exists in a target area, the segment areas of DP light reflected on the flat plane are distributed in the form of a matrix on the CMOS image sensor 123, as shown in FIG. 3B. For instance, light of a segment area S0 in the target area shown in FIG. 3A is entered to a segment area Sp shown in FIG. 3B, on the CMOS image sensor 123. In FIG. 3B, a light flux area of DP light is also indicated by a solid-line frame, and to simplify the description, a light flux of DP light is divided into segment areas arranged in the form of a matrix in the same manner as shown in FIG. 3A.

The three-dimensional distance calculator 21b is operable to perform detection (hereinafter, called as “pattern matching”) at which position on the CMOS image sensor 123, light of each segment area is entered, for detecting a distance to each portion of an object to be detected (an irradiation position of each segment area), based on a light receiving position on the CMOS image sensor 123, using a triangulation method. The details of the above detection method is disclosed in e.g. pp. 1279-1280, the 19th Annual Conference Proceedings (Sep. 18-20, 2001) by the Robotics Society of Japan.

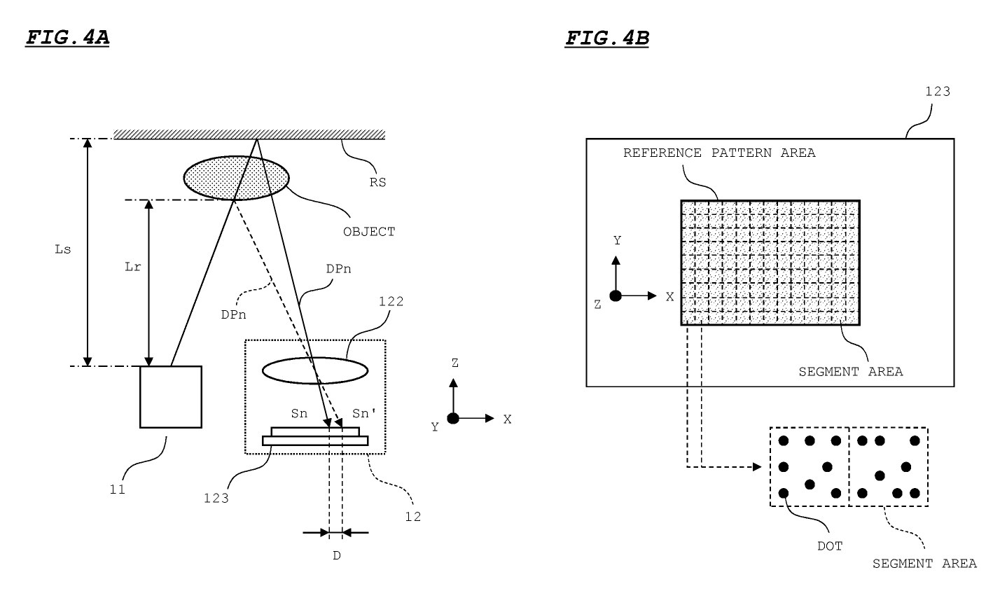

FIGS. 4A, 4B are diagrams schematically showing a reference template generation method for use in the aforementioned distance detection.

As shown in FIG. 4A, at the time of generating a reference template, a reflection plane RS perpendicular to Z-axis direction is disposed at a position away from the projection optical system 11 by a predetermined distance Ls. The temperature of the laser light source 111 is retained at a predetermined temperature (reference temperature). Then, DP light is emitted from the projection optical system 11 for a predetermined time Te in the above state. The emitted DP light is reflected on the reflection plane RS, and is entered to the CMOS image sensor 123 in the light receiving optical system 12. By performing the above operation, an electrical signal at each pixel is outputted from the CMOS image sensor 123. The value (pixel value) of the electrical signal at each outputted pixel is expanded in the memory 25 shown in FIG. 2.

As shown in FIG. 4B, a reference pattern area for defining an irradiation area of DP light on the CMOS image sensor 123 is set, based on the pixel values expanded in the memory 25. Further, the reference pattern area is divided into segment areas in the form of a matrix. As described above, dots locally appear with a unique pattern in each segment area. Accordingly, each segment area has a different pattern of pixel values. Each one of the segment areas has the same size as all the other segment areas.

The reference template is configured in such a manner that pixel values of the pixels included in each segment area set on the CMOS image sensor 123 are correlated to the segment area.

Specifically, the reference template includes information relating to the position of a reference pattern area on the CMOS image sensor 123, pixel values of all the pixels included in the reference pattern area, and information for use in dividing the reference pattern area into segment areas. The pixel values of all the pixels included in the reference pattern area correspond to a dot pattern of DP light included in the reference pattern area. Further, pixel values of pixels included in each segment area are acquired by dividing a mapping area on pixel values of all the pixels included in the reference pattern area into segment areas. The reference template may retain pixel values of pixels included in each segment area, for each segment area.

The reference template thus configured is stored in the memory 25 shown in FIG. 2 in a non-erasable manner. The reference template stored in the memory 25 is referred to in calculating a distance from the projection optical system 11 to each portion of an object to be detected.

For instance, in the case where an object is located at a position nearer to the distance Ls shown in FIG. 4A, DP light (DPn) corresponding to a segment area Sn on the reference pattern is reflected on the object, and is entered to an area Sn′ different from the segment area Sn. Since the projection optical system 11 and the light receiving optical system 12 are adjacent to each other in X-axis direction, the displacement direction of the area Sn′ relative to the segment area Sn is aligned in parallel to X-axis. In the case shown in FIG. 4A, since the object is located at a position nearer to the distance Ls, the area Sn′ is displaced relative to the segment area Sn in plus X-axis direction. If the object is located at a position farther from the distance Ls, the area Sn′ is displaced relative to the segment area Sn in minus X-axis direction.

A distance Lr from the projection optical system 11 to a portion of the object irradiated with DP light (DPn) is calculated, using the distance Ls, and based on a displacement direction and a displacement amount of the area Sn′ relative to the segment area Sn, by a triangulation method. A distance from the projection optical system 11 to a portion of the object corresponding to the other segment area is calculated in the same manner as described above.

In performing the distance calculation, it is necessary to detect to which position, a segment area Sn of the reference template has displaced at the time of actual measurement. The detection is performed by performing a matching operation between a dot pattern of DP light irradiated onto the CMOS image sensor 123 at the time of actual measurement, and a dot pattern included in the segment area Sn.

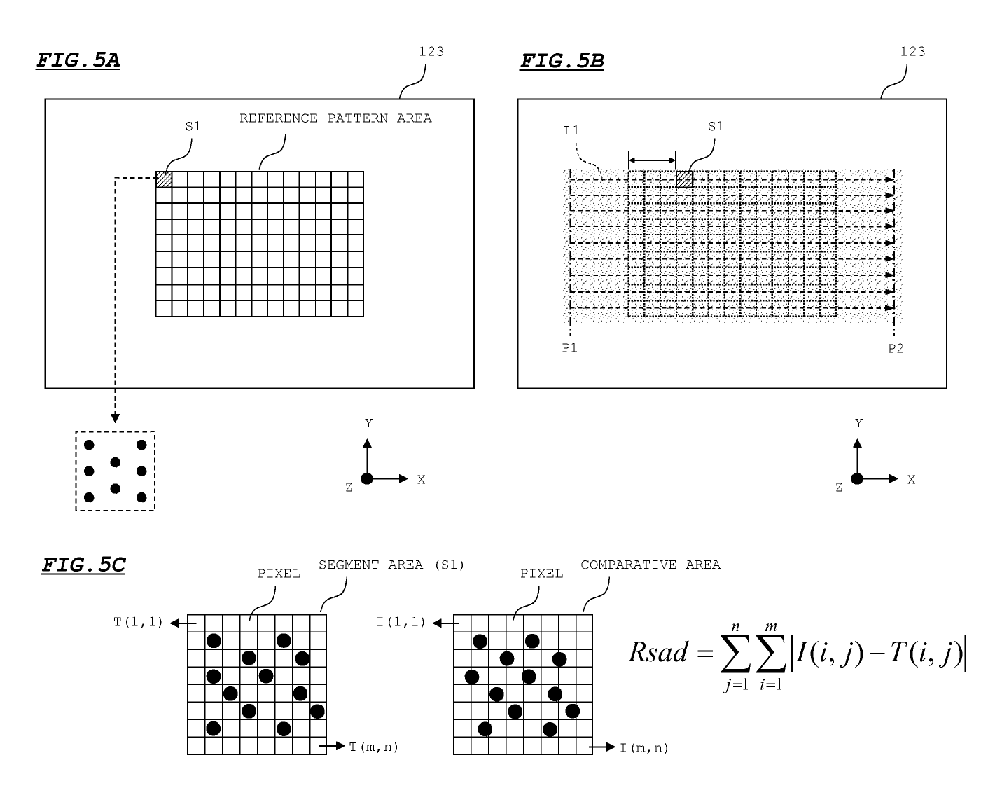

FIGS. 5A through 5C are diagrams for describing the aforementioned detection method. FIG. 5A is a diagram showing a state as to how a reference pattern area and a segment area are set on the CMOS image sensor 123, FIG. 5B is a diagram showing a segment area searching method to be performed at the time of actual measurement, and FIG. 5C is a diagram showing a matching method between an actually measured dot pattern of DP light, and a dot pattern included in a segment area of a reference template.

For instance, in the case where a displacement position of a segment area S1 at the time of actual measurement shown in FIG. 5A is searched, as shown in FIG. 5B, the segment area S1 is fed pixel by pixel in X-axis direction in a range from P1 to P2 for obtaining a matching degree between the dot pattern of the segment area S1, and the actually measured dot pattern of DP light, at each feeding position. In this case, the segment area S1 is fed in X-axis direction only on a line L1 passing an uppermost segment area group in the reference pattern area. This is because, as described above, each segment area is normally displaced only in X-axis direction from a position set by the reference template at the time of actual measurement. In other words, the segment area S1 is conceived to be on the uppermost line L1. By performing a searching operation only in X-axis direction as described above, the processing load for searching is reduced.

At the time of actual measurement, a segment area may be deviated in X-axis direction from the range of the reference pattern area, depending on the position of an object to be detected. In view of the above, the range from P1 to P2 is set wider than the X-axis directional width of the reference pattern area.

At the time of detecting the matching degree, an area (comparative area) of the same size as the segment area S1 is set on the line L1, and a degree of similarity between the comparative area and the segment area S1 is obtained. Specifically, there is obtained a difference between the pixel value of each pixel in the segment area S1, and the pixel value of a pixel, in the comparative area, corresponding to the pixel in the segment area S1. Then, a value Rsad which is obtained by summing up the difference with respect to all the pixels in the comparative area is acquired as a value representing the degree of similarity.

For instance, as shown in FIG. 5C, in the case where pixels of m columns by n rows are included in one segment area, there is obtained a difference between a pixel value T (i, j) of a pixel at i-th column, j-th row in the segment area, and a pixel value I (i, j) of a pixel at i-th column, j-th row in the comparative area. Then, a difference is obtained with respect to all the pixels in the segment area, and the value Rsad is obtained by summing up the differences. In other words, the value Rsad is calculated by the following formula.

$$Rsad = {\sum }_{j = 1}^{n} {\sum }_{i = 1}^{m} \vert I ( i , j ) - T ( i , j ) \vert$$

As the value Rsad is smaller, the degree of similarity between the segment area and the comparative area is high.

At the time of a searching operation, the comparative area is sequentially set in a state that the comparative area is displaced pixel by pixel on the line L1. Then, the value Rsad is obtained for all the comparative areas on the line L1. A value Rsad smaller than a threshold value is extracted from among the obtained values Rsad. In the case where there is no value Rsad smaller than the threshold value, it is determined that the searching operation of the segment area S1 has failed. In this case, a comparative area having a smallest value among the extracted values Rsad is determined to be the area to which the segment area S1 has moved. The segment areas other than the segment area S1 on the line L1 are searched in the same manner as described above. Likewise, segment areas on the other lines are searched in the same manner as described above by setting a comparative area on the other line.

In the case where the displacement position of each segment area is searched from the dot pattern of DP light acquired at the time of actual measurement in the aforementioned manner, as described above, the distance to a portion of the object to be detected corresponding to each segment area is obtained based on the displacement positions, using a triangulation method.

FIG. 6 is a perspective view showing an installation state of the projection optical system 11 and the light receiving optical system 12.

The projection optical system 11 and the light receiving optical system 12 are mounted on a base plate 300 having a high heat conductivity. The optical members constituting the projection optical system 11 are mounted on a chassis 11a. The chassis 11a is mounted on the base plate 300. With this arrangement, the projection optical system 11 is mounted on the base plate 300.

The light receiving optical system 12 is mounted on top surfaces of two base blocks 300a on the base plate 300, and on a top surface of the base plate 300 between the two base blocks 300a. The CMOS image sensor 123 to be described later is mounted on the top surface of the base plate 300 between the base blocks 300a. A holding plate 12a is mounted on the top surfaces of the base blocks 300a. A lens holder 12b for holding a filter 121 and an imaging lens 122 to be described later is mounted on the holding plate 12a.

The projection optical system 11 and the light receiving optical system 12 are aligned in X-axis direction away from each other with a predetermined distance in such a manner that the projection center of the projection optical system 11 and the imaging center of the light receiving optical system 12 are linearly aligned in parallel to X-axis. A circuit board 200 (see FIG. 7) for holding the circuit section (see FIG. 2) of the information acquiring device 1 is mounted on the back surface of the base plate 300.

A hole 300b is formed in the center of a lower portion of the base plate 300 for taking out a wiring of a laser light source 111 from a back portion of the base plate 300. Further, an opening 300c for exposing a connector 12c of the CMOS image sensor 123 from the back portion of the base plate 300 is formed in the portion of the base plate 300 lower than the position where the light receiving optical system 12 is installed.

The left half portion of the device shown in FIG. 6 constitutes a projection device, and the right half portion of the device shown in FIG. 6 constitutes a light receiving device.

The projection device shown in the left half portion corresponds to a projection device of the invention.

FIG. 7 is a diagram schematically showing an arrangement of the projection optical system 11 and the light receiving optical system 12 in the embodiment.

The projection optical system 11 is provided with the laser light source 111, a collimator lens 112, a rise-up mirror 113, and a DOE (Diffractive Optical Element) 114. Further, the light receiving optical system 12 is provided with the filter 121, the imaging lens 122, and the CMOS image sensor 123.

The laser light source 111 outputs laser light of a narrow wavelength band of or about 830 nm. The laser light source 111 is disposed in such a manner that the optical axis of laser light is aligned in parallel to X-axis. The collimator lens 112 converts the laser light emitted from the laser light source 111 into substantially parallel light. The collimator lens 112 is disposed in such a manner that the optical axis thereof is aligned with the optical axis of laser light emitted from the laser light source 111. The rise-up mirror 113 reflects laser light entered from the collimator lens 112 side. The optical axis of laser light is bent by 90° by the rise-up mirror 113 and is aligned in parallel to Z-axis.

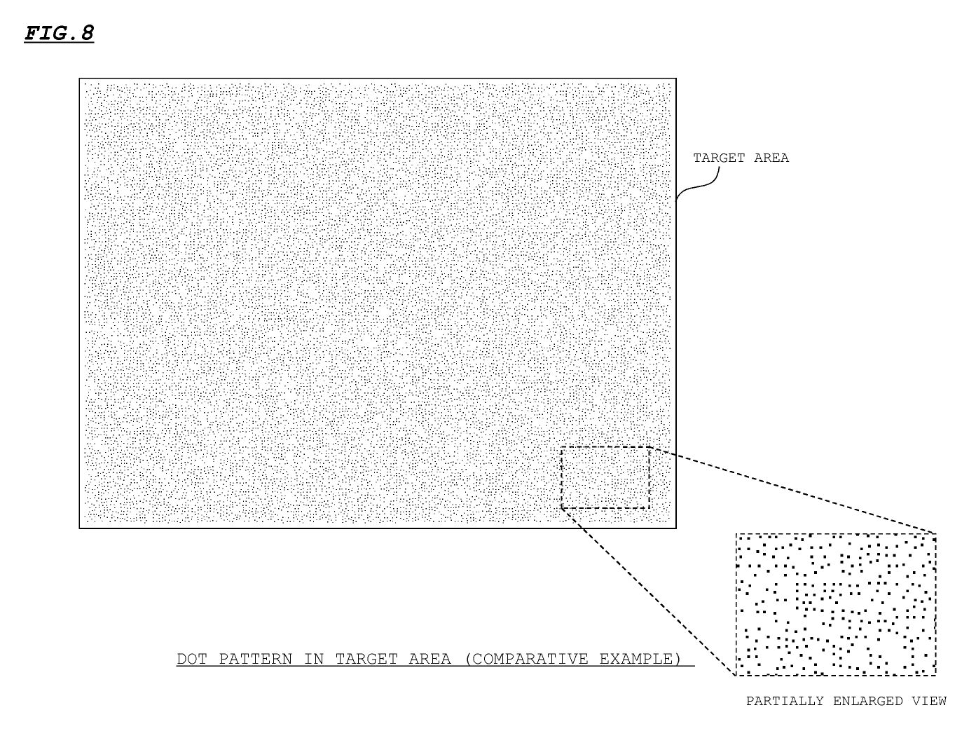

The DOE 114 has a diffraction pattern on a light incident surface thereof. The DOE 114 is formed by e.g. injection molding using resin, or by subjecting a glass substrate to lithography or dry-etching. The diffraction pattern is formed by e.g. step-type hologram. Laser light reflected on the rise-up mirror 113 and entered to the DOE 114 is converted into laser light having a dot pattern by a diffractive action of the diffraction pattern, and is irradiated onto a target area. The diffraction pattern is designed to have a predetermined dot pattern in a target area. The dot pattern in the target area will be described later referring to FIGS. 8 through 10.

Laser light reflected on the target area is entered to the imaging lens 122 through the filter 121.

The filter 121 transmits light of a wavelength band including the emission wavelength (of or about 830 nm) of the laser light source 111, and blocks light of the other wavelength band. The imaging lens 122 condenses light entered through the filter 121 on the CMOS image sensor 123. The imaging lens 122 is constituted of plural lenses, and an aperture and a spacer are interposed between a lens and another lens of the imaging lens 122. The aperture limits external light to be in conformity with the F-number of the imaging lens 122.

The CMOS image sensor 123 receives light condensed on the imaging lens 122, and outputs a signal (electric charge) in accordance with a received light amount to the image signal processing circuit 23 pixel by pixel. In this example, the CMOS image sensor 123 is configured to perform high-speed signal output so that a signal (electric charge) of each pixel can be outputted to the image signal processing circuit 23 with a high response from a light receiving timing at each of the pixels.

The filter 121 is disposed in such a manner that the light receiving surface thereof extends perpendicular to Z-axis. The imaging lens 122 is disposed in such a manner that the optical axis thereof extends in parallel to Z-axis. The CMOS image sensor 123 is disposed in such a manner that the light receiving surface thereof extends perpendicular to Z-axis. Further, the filter 121, the imaging lens 122 and the CMOS image sensor 123 are disposed in such a manner that the center of the filter 121 and the center of the light receiving area of the CMOS image sensor 123 are aligned on the optical axis of the imaging lens 122.

As described above referring to FIG. 6, the projection optical system 11 and the light receiving optical system 12 are mounted on the base plate 300. Further, the circuit board 200 is mounted on the lower surface of the base plate 300, and wirings (flexible substrates) 201 and 202 are connected from the circuit board 200 to the laser light source 111 and to the CMOS image sensor 123. The circuit section of the information acquiring device 1 such as the CPU 21 and the laser driving circuit 22 shown in FIG. 2 is mounted on the circuit board 200.

In the arrangement shown in FIG. 7, the DOE 114 is normally designed in such a manner that dots of a dot pattern are uniformly distributed with the same luminance in a target area. By distributing the dots in the aforementioned manner, it is possible to search a target area uniformly. As a result of actually generating a dot pattern using the thus designed DOE 114, however, it has been found that the luminance of dots varies depending on the areas. Further, it has been found that the luminance variation among the dots has a certain tendency. The following is a description about an analysis and an evaluation of the DOE 114 conducted by the inventor of the present application.

Firstly, as a comparative example, the inventor of the present application adjusted a diffraction pattern of a DOE 114 in such a manner that dots of a dot pattern were uniformly distributed with the same luminance in a target area.

FIG. 8 is a diagram showing a simulation example of a dot pattern in a target area in the comparative example. As shown in FIG. 8, the DOE 114 as the comparative example is designed to distribute dots of a dot pattern with the same luminance and with a uniform density in a target area.

Next, the inventor of the present application actually projected light having a dot pattern onto a target area, using the DOE 114 (comparative example) constructed according to the aforementioned design, and captured a projection state of the dot pattern at the time of projection by the CMOS image sensor 123. Then, the inventor measured a luminance distribution of the dot pattern on the CMOS image sensor 123, based on a received light amount (detection signal) of each pixel on the CMOS image sensor 123.

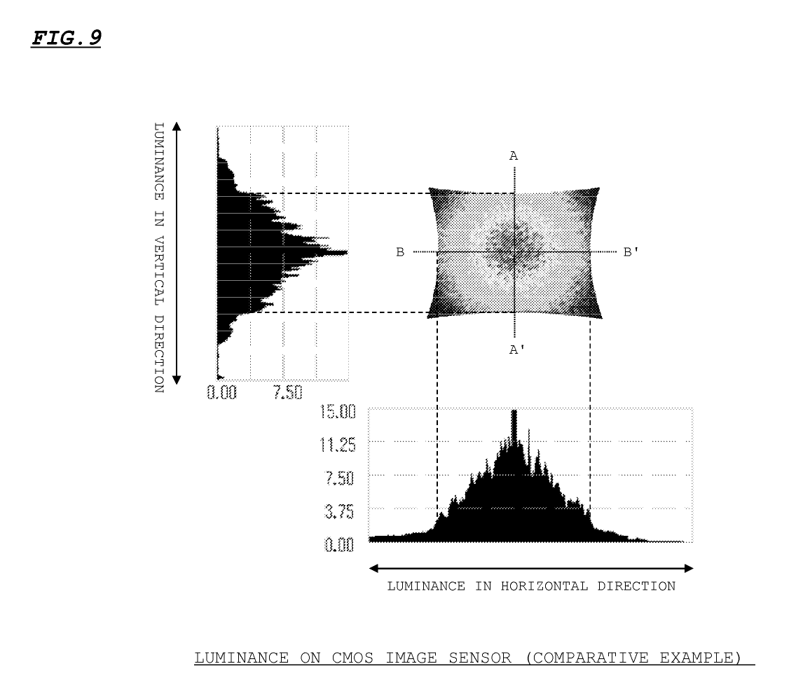

FIG. 9 shows a measurement result about a luminance distribution on the CMOS image sensor 123, in the case where the DOE 114 as the comparative example is used. In the center portion of FIG. 9, there is illustrated a luminance distribution diagram showing luminances on the light receiving surface (two-dimensional plane) of the CMOS image sensor 123 in colors (in FIG. 9, a luminance variation is expressed by color difference). In the left portion of FIG. 9 and the lower portion of FIG. 9, there are illustrated graphs respectively showing luminance values taken along the line A-A′ and the line B-B′ of the luminance distribution diagram. The left-side graph and the lower-side graph are respectively normalized by setting a maximum luminance to 15. As shown in the left-side graph and the lower-side graph of FIG. 9, actually, there exist luminances in a region in the periphery of the diagram shown in the center portion of FIG. 9. However, since the luminances in the region are low, to simplify the description, the diagram shown in the center portion of FIG. 9 does not show the luminances in the region.

As shown in FIG. 9, the luminance on the CMOS image sensor 123 is such that the luminance in the center of the CMOS image sensor 123 is maximum, and that the luminance lowers as the position of the dot is away from the center of the CMOS image sensor 123. As described above, even in the case where the DOE 114 is designed to make the density of dots in a target area uniform, actually, the luminance varies on the CMOS image sensor 123. Specifically, the above measurement result shows that the dot pattern projected onto a target area has a tendency that the luminance of dots lowers, as the position of the dot is shifted from the center toward an end portion of the CMOS image sensor 123.

If the luminance varies as described above, observing the vicinity of the center and the vicinity of the periphery of the CMOS image sensor 123, dots are less likely to be detected in the vicinity of the periphery where the luminance is low, resulting from stray light such as natural light or light from an illuminator, although the number of dots to be included in each segment area is substantially the same. Thus, the precision in pattern matching may be degraded in a segment area in the vicinity of the periphery of the CMOS image sensor 123.

Referring to the luminance distribution diagram shown in the center portion of FIG. 9, it is clear that the luminance of dots radially changes from the center of the CMOS image sensor 123. In other words, it is conceived that dots having substantially the same luminance are distributed substantially concentrically with respect to the center of a dot pattern, and the luminance of dots gradually lowers as the position of the dot is shifted away from the center. The inventor of the present application conducted the same measurement as described above for plural DOEs 114 that have been designed in the same manner as described above. As a result of the measurement, the same tendency was confirmed for any one of the DOEs 114. Accordingly, it is conceived that in the case where a DOE 114 is designed in such a manner that dots of a dot pattern are uniformly distributed with the same luminance in a target area, generally, the dots to be projected onto the target area are distributed with the aforementioned tendency.

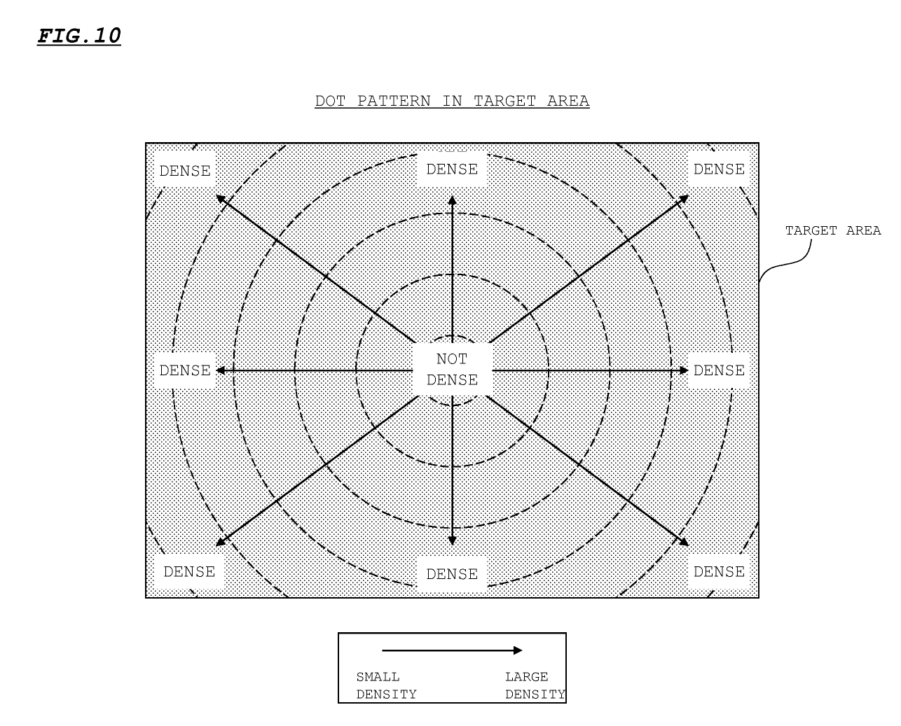

In view of the above, in the embodiment, as shown in FIG. 10, the diffraction pattern of the DOE 114 is adjusted in such a manner that a dot pattern is non-uniformly distributed in a target area.

FIG. 10 is a diagram schematically showing a dot distribution state in a target area in the embodiment. As shown in FIG. 10, the DOE 114 in the embodiment is formed in such a manner that the density of dots increases as the position of the dot is shifted concentrically away from the center in a target area (namely, in proportion to a distance from the center) by a diffractive action of the DOE 114. Each portion shown by a broken line in FIG. 10 represents a region where the density of dots is substantially equal to each other.

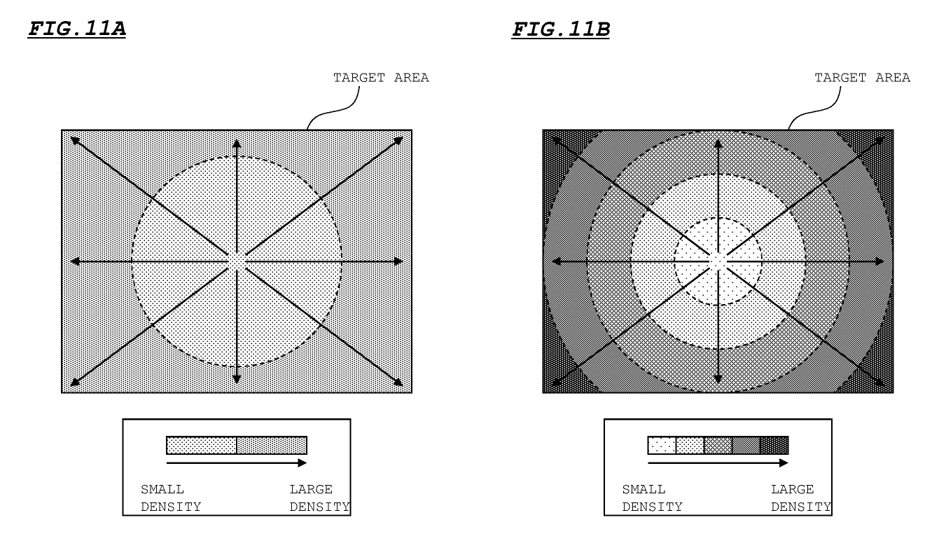

The density of dots may be linearly increased or stepwise increased, as the position of the dot is shifted radially away from the center of the dot pattern. For instance, in the case where the density of dots is stepwise increased, as shown in FIGS. 11A and 11B, plural regions are concentrically set from the center of a dot pattern, and the density of dots within each region is made equal to each other. In FIGS. 11A and 11B, a region where the density of dots is equal to each other is indicated with the same gradation.

In the case where the density of dots is adjusted as described above, it is desirable to change only the density of dots while retaining the same number of dots as in the case of the comparative example. Specifically, as far as the light emission amount of the laser light source 111 is retained unchanged, the light amount (luminance) per dot lowers, as the number of dots increases. In view of the above, if the number of dots in a peripheral portion of a dot pattern increases without changing the number of dots in a center portion of the dot pattern for the purpose of increasing the density of dots in the peripheral portion of the dot pattern, the number of dots in the entirety of the dot pattern increases, and the light amount (luminance) per dot lowers. In such a case, it is impossible to detect a dot, which has been detectable before the density of dots is changed, because the density of dots has been increased. As a result, the effect by increasing the density of dots is not sufficiently obtained. In view of the above, in the case where the number of dots is set to a predetermined value (e.g. 20,000) based on various design conditions, it is desirable to adjust the density of dots as described above referring to FIG. 10 in a state that the aforementioned number is retained.

Even if the density of dots is adjusted as described in the embodiment, the luminance of dots changes with the same tendency as evaluated in FIG. 9. Specifically, the luminance of each dot in the center of a dot pattern is high, and the luminance gradually lowers, as the position of the dot is shifted radially away from the center.

As described above, according to the embodiment, although there is a luminance variation in a region on the inner side and the outer side of a target area in the same manner as in the comparative example, the density of dots increases in the vicinity of the outer side where the luminance is low. Thereby, in performing a pattern matching operation for a segment area in the vicinity of the outer side of the target area, the number of dots to be included in the segment area increases. Accordingly, as described below, the precision in pattern matching can be enhanced. Thus, it is possible to increase the distance detection precision of the object detecting device.

For instance, let it be assumed that the number of pixels in the area on the CMOS image sensor 123 corresponding to a target area is 200,000, and the total number of dots of a dot pattern is 20,000. Then, assuming that a segment area has a size of 9 pixels by 9 pixels=81 pixels, in the case where the dots are uniformly distributed (comparative example), around eight dots are included in one segment area. On the other hand, if the density of dots in a peripheral portion of a dot pattern increases by two times (present example), around sixteen dots are included in one segment area. In the case where stray light is entered to a segment area, an increase in the dot number may increase the number of dots that do not disappear by stray light. Accordingly, it is easy to perform a matching operation for a segment area.

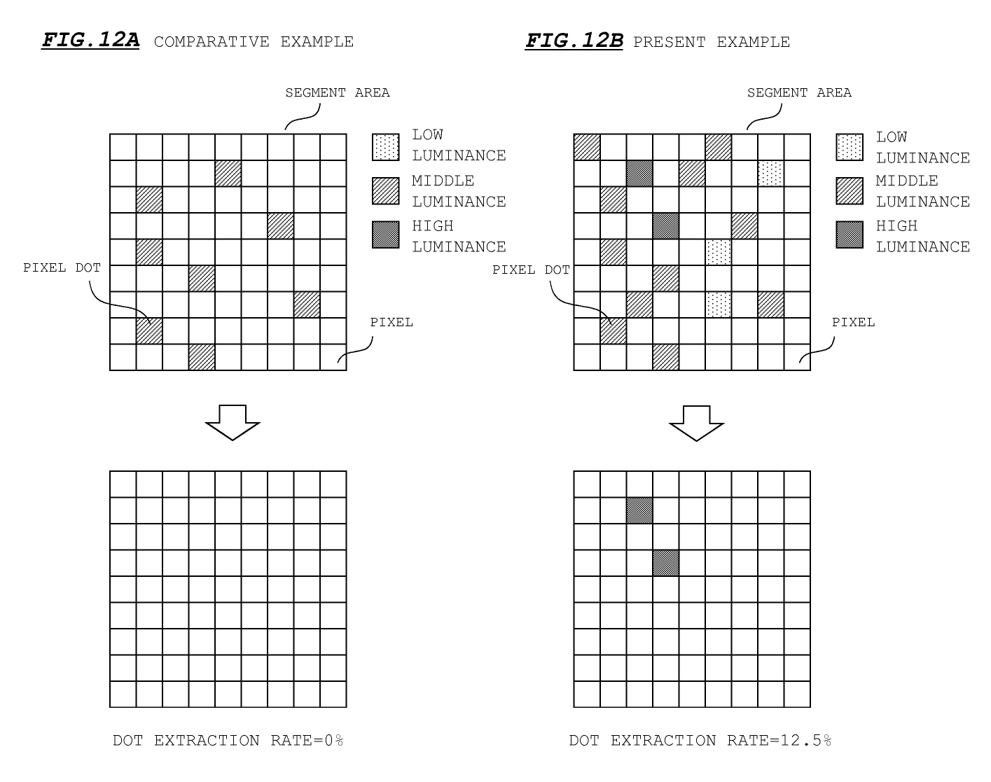

For instance, in the example shown in FIG. 12A, in the case where the luminance level of stray light lies between a middle luminance and a high luminance (e.g. a level slightly higher than the medium level), all the dots merge into stray light in the comparative example. In the comparative example, the extraction rate of detectable dots with respect to dots that should be detected is 0%. Normally, in this case, detection of the target segment area fails. On the other hand, in the present example, the luminance of some of the eight dots that are added with respect to the comparative example may exceed the luminance level of stray light. For instance, as shown in FIG. 12B, if the luminance of two dots out of the added eight dots exceeds the luminance level of stray light, the dot extraction rate is 12.5%. Thus, the possibility of detecting the target segment area increases.

In the case where the luminance of the added eight dots is not a high luminance (including a case that many dots have a low luminance, in addition to the case where the luminance of the added eight dots is a middle luminance), dots are not extracted. However, since dots are also not extracted in a case before the eight dots are added, in the above case, the measurement result does not change before and after the eight dots are added. The present example has a technical effect that an increase in the number of dots to be included in one segment area increases a possibility of detecting a segment area that may not or can not be detected before the number of dots increases.

In the example shown in FIG. 12B, the density of dots in a peripheral portion of a dot pattern increases by two times. In this example, the density of dots in the center portion of the dot pattern is set to e.g. ½. If the density of dots in the center portion is set as described above, the number of dots to be included in a segment area in the center portion is around four. However, since the luminance of dots is high in the center portion of the dot pattern, the dot extraction rate increases, and it is possible to properly detect a segment area, regardless that the number of dots is around four.

If the density of dots is set as described above, the density of dots in a peripheral portion of a dot pattern is four times as high as the density of dots in a center portion of the dot pattern. The ratio of the density of dots between a center portion and a peripheral portion of a dot pattern is not limited to the above, but the ratio may be set to such a value that the density of dots in the peripheral portion increases so that a desirable detection rate of a segment area is obtained. Further, the number of pixels in one segment area is not limited to 9 pixels by 9 pixels, but may be any pixel number. The ratio of the density of dots between a center portion and a peripheral portion of a dot pattern may be adjusted properly depending on the number of pixels in one segment area.

The embodiment of the invention has been described as above. The invention is not limited to the foregoing embodiment, and the embodiment of the invention may be changed or modified in various ways other than the above.

For instance, in the embodiment, the CMOS image sensor 123 is used as a photodetector. Alternatively, a CCD image sensor may be used in place of the CMOS image sensor.

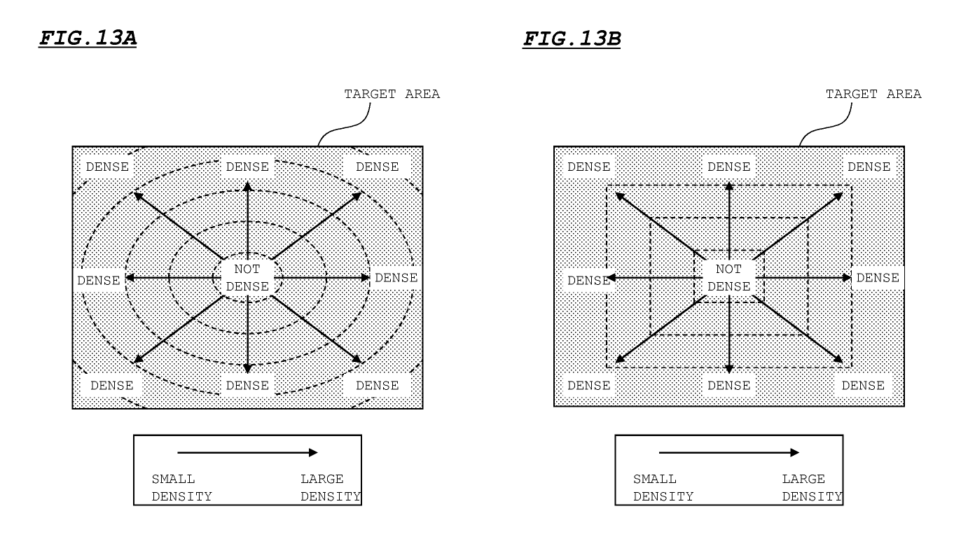

Further, in the embodiment, as shown in FIG. 10, the density of dots in a target area is configured to increase, as the position of the dot is shifted concentrically away from the center of the CMOS image sensor 123. Alternatively, as shown FIGS. 13A and 13B, the density of dots in a target area may be configured to increase, as the position of the dot is shifted elliptically and rectangularly away from the center. In the modification, the density of dots may be linearly increased, as the position of the dot is shifted radially away from the center of a dot pattern, or may be stepwise increased, as shown in FIGS. 11A and 11B.

Further, in the embodiment, the laser light source 111 and the collimator lens 112 are aligned in X-axis direction, and the rise-up mirror 113 is formed to bend the optical axis of laser light in Z-axis direction. Alternatively, the laser light source 111 may be disposed in such a manner as to emit laser light in Z-axis direction; and the laser light source 111, the collimator lens 112, and the DOE 114 are aligned in Z-axis direction. In the modification, although the rise-up mirror 113 can be omitted, the size of the projection optical system 11 increases in Z-axis direction.

Further, in the embodiment, segment areas adjacent to each other are set without overlapping each other. Alternatively, segment areas may be set in such a manner that a certain segment area, and segment areas adjacent to the certain segment area in up and down directions or in left and right directions may overlap each other.

The embodiment of the invention may be changed or modified in various ways as necessary, as far as such changes and modifications do not depart from the scope of the claims of the invention hereinafter defined.

What is claimed is:

1. An information acquiring device for acquiring information on a target area using light, comprising:
a projection optical system which projects laser light onto the target area with a predetermined dot pattern; and
a light receiving optical system which is aligned with the projection optical system in a certain direction away from the projection optical system with a predetermined distance, and captures an image of the target area, wherein
the projection optical system includes a laser light source, and a diffractive optical element which converts laser light emitted from the laser light source into light having a dot pattern by diffraction, and
the light receiving optical system includes an image sensor, and a condensing lens which condenses light from the target area on the image sensor, and
the diffractive optical element is formed in such a manner that a density of dots in a peripheral portion of the dot pattern is set larger than a density of dots in a center portion of the dot pattern in the target area.

2. The information acquiring device according to claim 1, wherein
the diffractive optical element is formed in such a manner that the density of dots in the target area increases in accordance with a distance from a center of the dot pattern in the target area.

3. The information acquiring device according to claim 2, wherein
the diffractive optical element is formed in such a manner that the density of dots stepwise increases, as a position of the dot is shifted radially away from the center of the dot pattern.

4. The information acquiring device according to claim 1, wherein
the projection optical system further includes a collimator lens which converts the laser light emitted from the laser light source into parallel light, and
the diffractive optical element converts the laser light as the parallel light converted by the collimator lens into light having a dot pattern by diffraction.

5. A projection device, comprising:
a projection optical system which projects laser light onto a target area with a predetermined dot pattern,
the projection optical system including:
a laser light source; and
a diffractive optical element which converts laser light emitted from the laser light source into light having a dot pattern by diffraction, wherein
the diffractive optical element is formed in such a manner that a density of dots in a peripheral portion of the dot pattern is set larger than a density of dots in a center portion of the dot pattern in the target area.

6. The projection device according to claim 5, wherein
the diffractive optical element is formed in such a manner that the density of dots in the target area increases in accordance with a distance from a center of the dot pattern in the target area.

7. The projection device according to claim 6, wherein
the diffractive optical element is formed in such a manner that the density of dots stepwise increases, as a position of the dot is shifted radially away from the center of the dot pattern.

8. The projection device according to claim 5, wherein
the projection optical system further includes a collimator lens which converts the laser light emitted from the laser light source into parallel light, and
the diffractive optical element converts the laser light as the parallel light converted by the collimator lens into light having a dot pattern by diffraction.

9. An object detecting device, comprising:
an information acquiring device which acquires information on a target area using light,
the information acquiring device including:
a projection optical system which projects laser light onto the target area with a predetermined dot pattern; and
a light receiving optical system which is aligned with the projection optical system in a certain direction away from the projection optical system with a predetermined distance, and captures an image of the target area, wherein
the projection optical system includes a laser light source, and a diffractive optical element which converts laser light emitted from the laser light source into light having a dot pattern by diffraction, and
the light receiving optical system includes an image sensor, and a condensing lens which condenses light from the target area on the image sensor, and
the diffractive optical element is formed in such a manner that a density of dots in a peripheral portion of the dot pattern is set larger than a density of dots in a center portion of the dot pattern in the target area.

10. The object detecting device according to claim 9, wherein
the diffractive optical element is formed in such a manner that the density of dots in the target area increases in accordance with a distance from a center of the dot pattern in the target area.

11. The object detecting device according to claim 10, wherein
the diffractive optical element is formed in such a manner that the density of dots stepwise increases, as a position of the dot is shifted radially away from the center of the dot pattern.

12. The object detecting device according to claim 9, wherein
the projection optical system further includes a collimator lens which converts the laser light emitted from the laser light source into parallel light, and
the diffractive optical element converts the laser light as the parallel light converted by the collimator lens into light having a dot pattern by diffraction.
